(19) United States
(12) Patent Application Publication
(10) Pub. No.: US 2014/0244334 A1
(43) Pub. Date: Aug. 28, 2014

(54) FACILITATING ALLOCATION OF RESOURCES TO TASKS

(71) Applicant: ORACLE INTERNATIONAL CORPORATION, Redwood Shores, CA (US)

(72) Inventors: NILADRI SEKHAR DE, Hyderabad (IN); Surya Vedula, Hyderabad (IN)

(73) Assignee: Oracle International Corporation, Redwood Shores, CA (US)

(21) Appl. No.: 13/776,747

(22) Filed: Feb. 26, 2013

(51) Int. Cl. G06Q 10/06

(52) U.S. Cl. CPC G06Q 10/063118
USPC 705/7.17

(57) ABSTRACT

An aspect of the present invention facilitates allocation of resources to tasks. In an embodiment, a user provides inputs representing tasks, resources, and duration of allocation of each of the resources to respective tasks in respective days. A unified graphical interface (UGI) indicating the tasks, the corresponding resources allocated for each task, and an extent of utilization of each resource in each day, is displayed. According to another aspect, the UGI includes the identifiers and daily capacities of each resource along a first direction, a timeline identifying days along a second direction (perpendicular to the display of the first direction), and vertical columns, with each column corresponding to a respective resource, wherein a width of a column identifies the daily capacity of the corresponding resource.

### BACKGROUND OF THE INVENTION

1. Technical Field

The present disclosure relates to task management systems and more specifically to facilitating allocation of resources to tasks.

2. Related Art

A task generally refers to an activity to be performed. There are often situations when organizations are required to perform multiple related tasks, for example, as a part of a project. The tasks may be related for the overall objective, and be required to be performed in sequence, parallel, etc., for meeting such an objective.

Resources are often used (or consumed) in performance of the tasks. Resources generally refer to any people, goods, places (e.g., conference room), etc., required for the performance of tasks.

There is a general need to facilitate allocation of resources to different tasks. For example, a manager may logically divide a project into multiple tasks and then allocate the required people to respective specific tasks. There are accordingly provided tools which can be used by managers to specify such allocations. It is generally desirable that such tools be user-friendly (i.e., convenient for use).

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flow chart illustrating the manner in which allocation of resources to tasks is simplified according to an aspect of the present invention.

FIG. 3A illustrates the manner in which a unified graphical interface indicating the tasks, resources allocated for each task and extent of utilization of each resource is provided in one embodiment.

FIG. 3B illustrates the manner in which a manager is facilitated to allocate resources to tasks in one embodiment.

FIG. 3C illustrates example task constraints and corresponding visual indicators displayed in one embodiment.

FIG. 4 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention facilitates allocation of resources to tasks. In an embodiment, a user provides inputs representing tasks, resources, and duration of allocation of each of the resources to respective tasks in respective days. A unified graphical interface (UGI) indicating the tasks, the corresponding resources allocated for each task, and an extent of utilization of each resource in each day, is displayed.

According to another aspect of the present invention, the UGI includes the identifiers and daily capacities of each resource along a first direction, a timeline identifying days along a second direction (perpendicular to the display of the first direction), and vertical columns, with each vertical column corresponding to a respective resource, wherein a width of a vertical column identifies the daily capacity of the corresponding resource.

According to one more aspect of the present invention, the UGI displays task graphical objects (TGOs) representing respective tasks allocated to each of the resources. In one embodiment, a TGO placed in a vertical column (noted above) indicates that the resource corresponding to the vertical column is allocated the task represented by the TGO. The height of the TGO along the second direction (timeline) indicating a number of days the resource is allocated to the task, while the width of the TGO along the first direction (daily capacity) indicates a duration of allocation of the resource to the task for each of the number of days.

According to yet another aspect of the present invention, a set of unallocated tasks is also displayed contemporaneous with the UGI. Accordingly, a user is enabled to specify an input indicating that a TGO representing an unallocated task is to be placed in a first location in a vertical column. In response to the input, the TGO is shown starting at the first location in the vertical column indicating that the corresponding resource is allocated to the unallocated task.

In one embodiment, the tasks may be associated with different constraints such as a start date constraint, an end date constraint, maximum duration per day constraint, a predecessor constraint and successor constraint. Each of such constraints is indicated by a corresponding visual indicator associated with respective TGOs in the UGI, thereby facilitating a user to take into consideration such constraints while allocating resources to tasks using the UGI.

According to another aspect of the present invention, the UGI also facilitates a user to view the slack time for a resource, that is, the days between two (previous and next) tasks during which the resource is unallocated. In one embodiment, the user is allowed to move down (along the timeline) the TGO corresponding to the next task to a previous day after the end day of the previous task and to move up the TGO corresponding to the previous task to a next day before the start day of the next task, to attempt to reduce the slack time.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

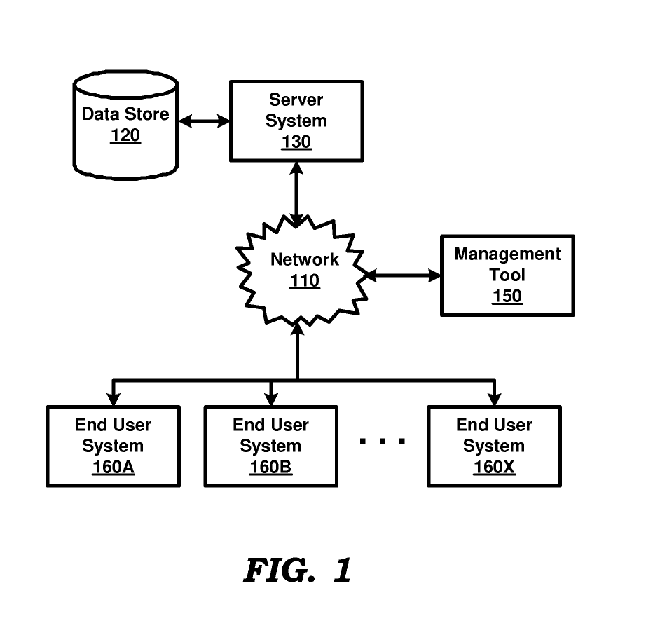

FIG. 1 is a block diagram illustrating an example environment in which several aspects of the present invention can be implemented. The block diagram is shown containing network 110, data store 120, server system 130, management tool 150 and end user systems 160A-160X.

Merely for illustration, only representative number/type of systems is shown in the Figure. Many environments often contain many more systems, both in number and type, depending on the purpose for which the environment is designed. Each system/device of FIG. 1 is described below in further detail.

Network 110 provides connectivity between server system 130, management tool 150 and end user systems 160A-160X, and may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Data store 120 represents a non-volatile (persistent) storage facilitating storage and retrieval of data (such as the details of the tasks, resources, and allocations of resources to the various tasks) by applications executing in server system 130. Data store 120 may be implemented as a corresponding database server using relational database technologies and accordingly provide storage and retrieval of data using structured queries such as SQL (Structured Query Language). Alternatively, data store 120 may be implemented as a corresponding file server providing storage and retrieval of data in the form of files organized as one or more directories, as is well known in the relevant arts.

Server system 130 represents a server, such as a web/application server, executing applications (such as a project management application that enables users to manage tasks, resources and the allocations between them) capable of processing (user) requests received from users using one of end user systems 160A-160X. The server system may use data stored internally (for example, in a non-volatile storage/hard disk within the system), external data (for example, stored in data stores such as 120) and/or data received from external sources (e.g., from the user) in processing of the user requests. The server system then sends the result of processing of the user requests to the requesting end user system (one of 160A-160X).

Each of end user systems 160A-160X represents a system such as a personal computer, workstation, mobile station, mobile phones, computing tablets, etc., used by users to generate (user) requests directed to applications executing in server system 130. The requests may be generated using appropriate user interfaces. For example, a manager may use an end user system to send user requests for managing the various tasks, resources and the corresponding allocations between them. On the other hand, an end user may send user requests to determine the specific tasks allocated to him/her (the resource), the start and end dates of the allocated tasks, the duration allocated for each task in respective days, etc.

In one prior approach, a manager/administrator of projects/tasks is required to use several tools to manage the tasks, resources and the corresponding allocations. For example, the manager may be required to use Gantt charts to view the various tasks of a project, the dependencies (in terms of time, implementation, etc.) between the tasks, and the different timelines (planned, actual, delay, etc.) for the tasks. Such Gantt chart applications generally enable the manager to (re)allocate tasks and to manage the schedule of the tasks.

In addition, the manager may be required to use resource allocation (RA) charts that displayed day-wise allocations for each resource, to identify whether each resource is under or over allocated on any given day. Such RA charts applications merely display the allocations, and do not facilitate (re)allocation of tasks or managing the attributes such as start date, end data, duration, etc. of a task. Accordingly, a manager may be required to switch between a Gantt chart and a RA chart application to achieve the task planning/management objectives.

The fragmentation of information across such multiple applications (and corresponding user interfaces) is generally considered to be inconvenient for managers responsible for task management/planning/allocation. It may accordingly be appreciated that a more user friendly (i.e., convenient for use) interface be provided to managers for task planning/management.

Management tool 150, provided according to several aspects of the present invention, facilitates the allocation of resources to tasks, while overcoming at least some of the drawbacks noted above. The manner in which management tool 150 may facilitate allocation of resources to tasks in described below with examples.

### 3. Simplifying Allocation of Resources to Tasks

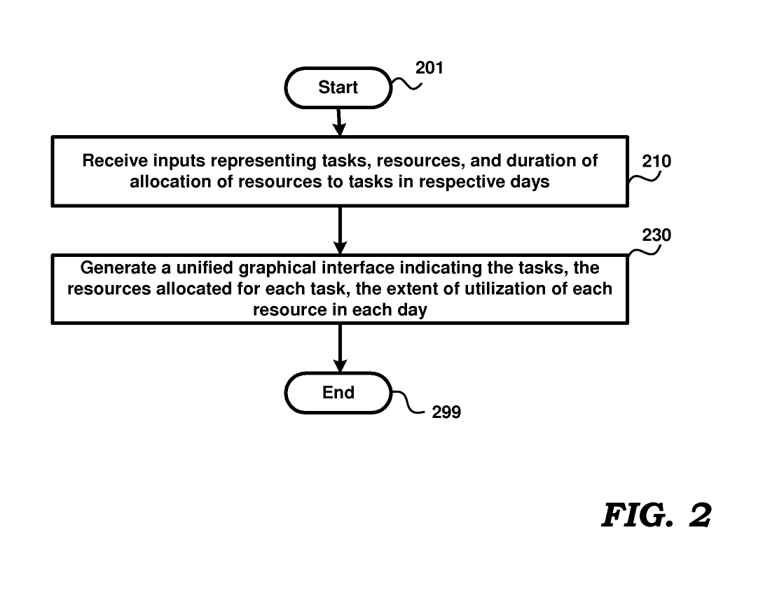

FIG. 2 is a flow chart illustrating the manner in which allocation of resources to tasks is simplified according to an aspect of the present invention. The flowchart is described with respect to the systems of FIG. 1, in particular, management tool 150, merely for illustration. However, the features can be implemented in other systems and environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, management tool 150 receives inputs representing tasks, resources, and duration of allocation of resources to tasks in respective days. The inputs can be received in any form, as suited in the specific environments. For example, the inputs may be based on interactive input interfaces complementing the unified graphical interface noted below, data received from external systems such as server system 130 (with the data being generated by other applications), etc. The input data can represent the initial state at some point of time and further changes to the resources, tasks, allocation, etc., also.

In step 230, management tool 150 generates a unified graphical interface (UGI) indicating the tasks, the resources allocated for each task, the extent of utilization of each resource in each day corresponding to the inputs. A unified interface with reference to different portions (i.e., tasks, resources, and allocations durations) of information implies that all of such portions are visible contemporaneously on a display screen. A graphical interface is contrasted with textual interface, where mere text/letters/language represents the information conveyed to human users. On the other hand, graphical interfaces employ graphical visual elements or objects (e.g., shapes, lines, size/positioning of the elements, etc.) to convey (to human users) the information corresponding to the inputs of step 210. The flowchart ends in step 299.

Due to the visibility of information corresponding to tasks, resources and allocation durations in such a UGI, managers may more conveniently allocate resources to tasks, as described below with examples.

### 4. Illustrative Examples

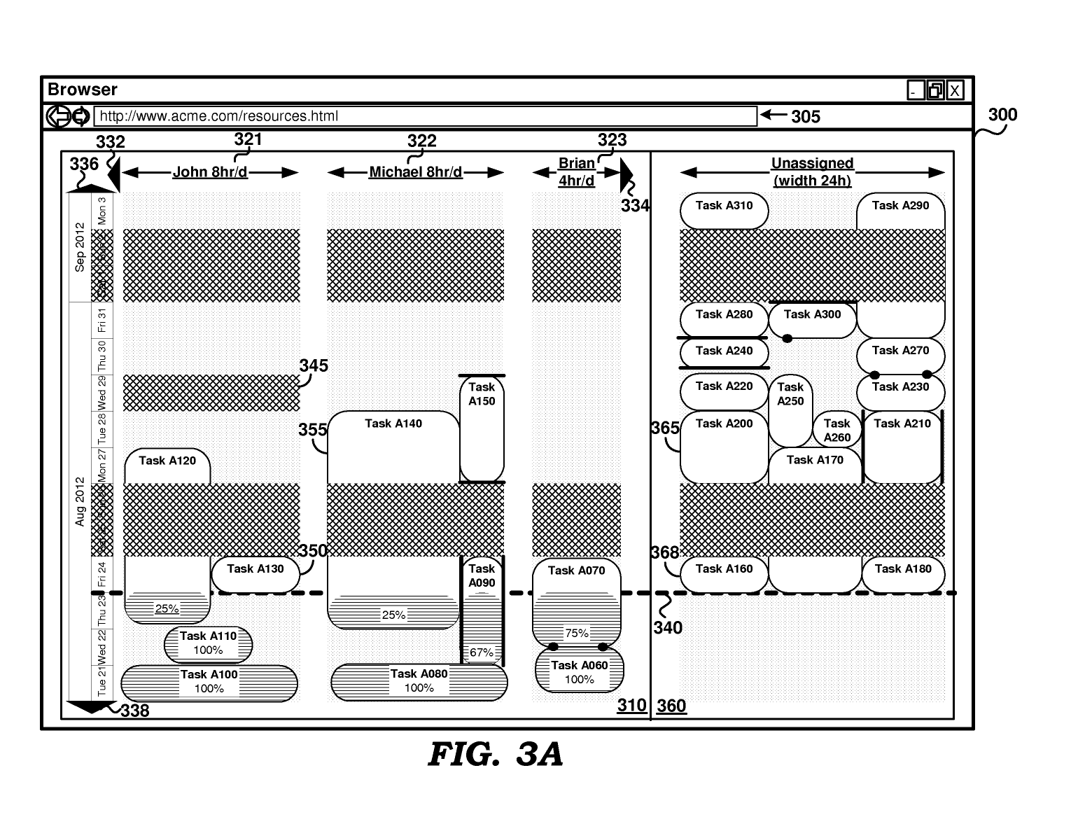

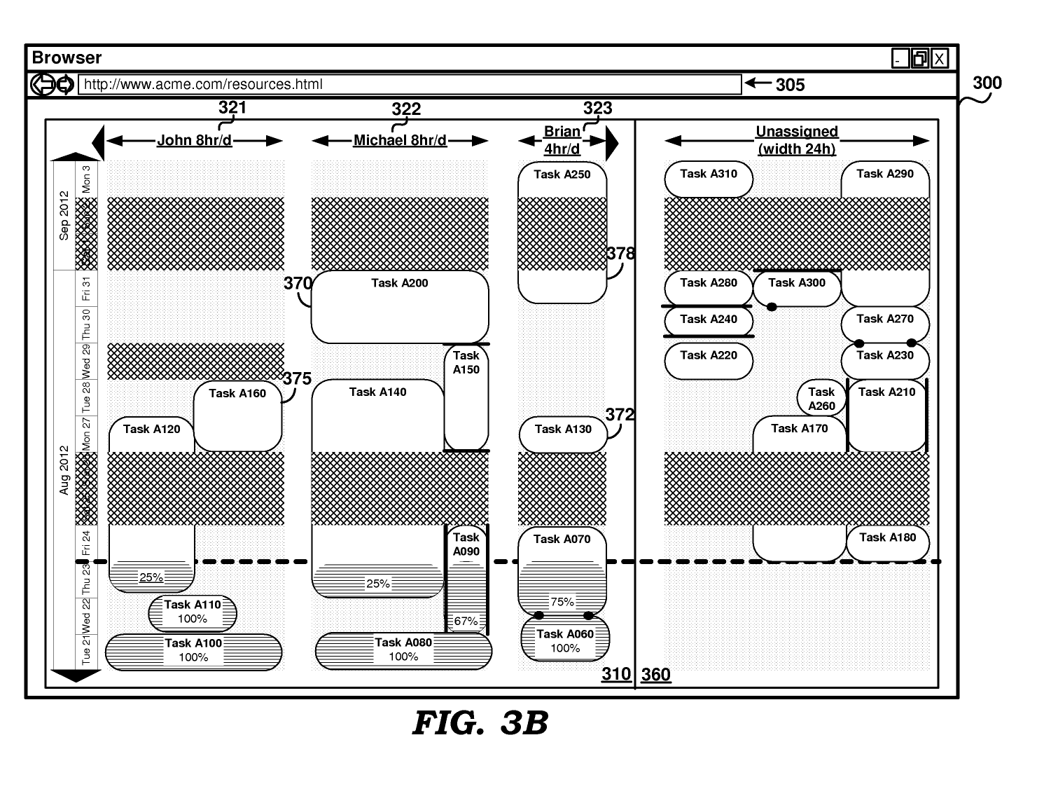

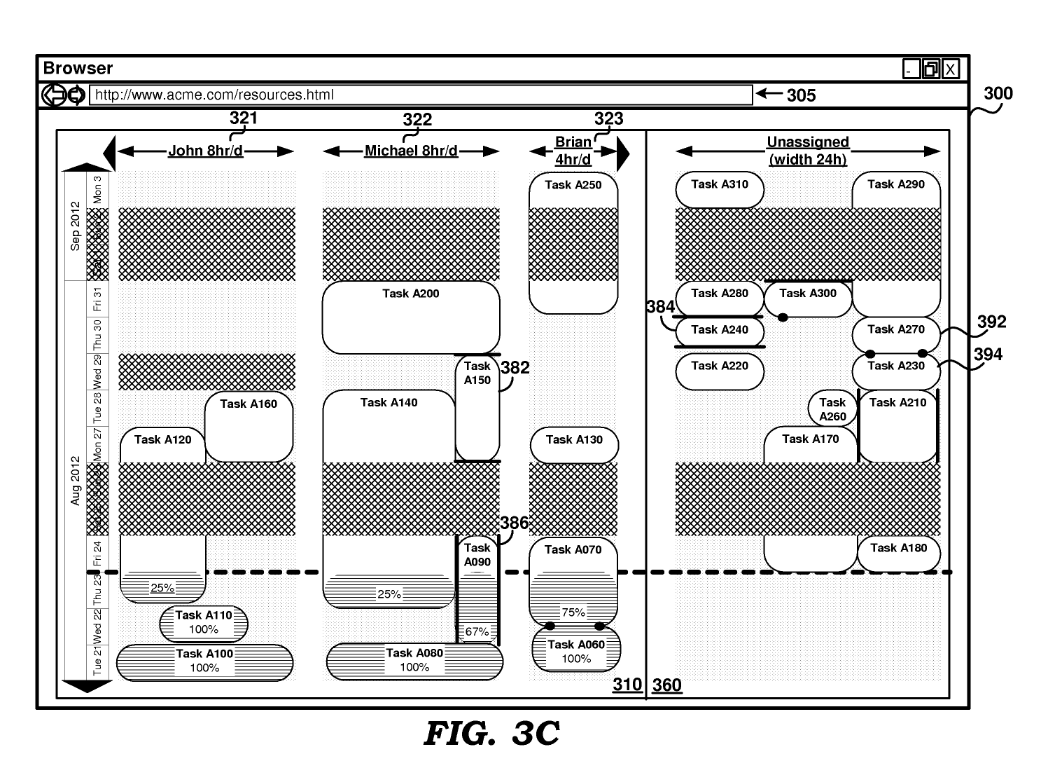

FIG. 3A illustrates the manner in which a unified graphical interface indicating the tasks, resources allocated for each task and extent of utilization of each resource is provided in one embodiment. Display area 300 of FIG. 3A (and also FIG. 3B) depicts a portion of a user interface provided on a display unit (not shown in FIG. 1) associated with one of end user systems 160A-160X (assumed to be 160A for illustration). Display area 300 corresponds to a webpage accessed by the users using a browser in response to sending a request (including an identifier of the webpage, as indicated by the text in display area 305) from end user system 160A to management tool 150. The web page is received from management tool 150 prior to being displayed (using the browser) on the display unit.

Broadly, the user interface of is shown containing UGI 310 and unassigned tasks 360. As described in below sections, a manager may drag and drop graphical objects from unassigned tasks 360 to UGI 310 to allocate corresponding resources to respective tasks, and similarly remove allocations of resources to tasks by moving the graphical objects from UGI 310 to unassigned tasks 360. In addition, UGI 310 enables a manager to move a previously allocated task to a different resource (reallocation). Each of UGI 310 and unassigned tasks 360, as relevant to such operations is described in detail below.

UGI 310, provided according to an aspect of the present invention, depicts a unified graphical interface for indicating the tasks, the resources allocated for each task, and the extent of utilization of each resource in each day. Accordingly, the identifiers of the resources (such as the names “John”, “Michael”, and “Brian” of people resources) are shown displayed along the horizontal direction (one of two directions). The total duration that each resource is commonly available per day (referred to as the daily capacity) is indicated along with the identifier of the resource. Thus the text “8 hr/d” alongside the resource “John” indicates that the daily capacity for John (that is, the duration that John is available per day) is 8 hours per day.

The daily capacity of each resource is visually displayed along the vertical direction (the other of the two directions, perpendicular to the first direction), as a corresponding vertical column 321-323 (shown shaded using dots) under the corresponding resource. It may be observed that the width of each of vertical columns 321-323 is shown corresponding to the daily capacity for the resource. For example, the width of vertical column 323 is shown to be half of the width of the vertical columns 321 and 322, since the daily capacity of 4 hours per day for “Brian” is half of the daily capacity of 8 hours per day for “John” and “Michael”.

Similarly, the identifiers and daily capacities of other resources may be displayed on the horizontal direction. A manager may click/select on the left and right arrows (332 and 334 respectively) to scroll and view the details of other resources. It may be appreciated that the number of vertical columns/resources that are contemporaneously displayed may be determined based on the width of display area 300 (which in turn may be determined by the width of the display screen, the width of the browser window as specified by a manager, etc.).

A calendar timeline indicating the various days of interest is shown displayed along the vertical direction. The timeline is shown indicating the months (such as “August 2012” and “September 2012”) and the corresponding days (Monday, Tuesday, etc.) of interest in each of the months. A thick dashed line (340) indicates the current date (Friday the 24^{th} of August 2012) in the calendar timeline. The dates before/below current date line 340 represent the dates in the past, while the dates after/above current date line 340 represent the dates in the future. In an alternative embodiment, current date line 340 may represent the last date (“last data date”) for which a complete status update (received from the resources) is available.

A manager may click/select on the up and down arrows (336 and 338 respectively) to scroll and view the details of other future/past dates. Similar to the vertical columns, the number of dates that are contemporaneously displayed may be determined based on the height of display area 300 (which in turn may be determined by the height of the display screen, the height of the browser window as specified by a manager, etc.).

It may be observed that non-working days such as Saturdays and Sundays are shown shaded as cross-hatched to indicate the non-availability (for allocation) of the resources during such days. The non-working days for individual resources, such as the days for which a people resource has applied for leave, the days during which a room/machine resource is not available due to maintenance, etc. may be similarly indicated. For example, the cross-hatched area 345 indicates that the resource “John” is not available on Wednesday the 29^{th} of August 2012, while the other resources are indicated to be available (due to absence of such a cross-hatched area in the corresponding vertical columns).

Thus, the daily capacities and the availability of the different resources are displayed to a manager. The manner in which the various tasks allocated to the different resources are depicted in UGI 310 is described below with examples.

### 5. Displaying Tasks

As may be readily observed, both UGI 310 and unassigned tasks 360 employ similar graphic objects for representing a task. Each task graphical object (TGO) is shown in the form of a rounded rectangle with the name of the task (such as “Task A120”, “Task A270”, etc.) shown at the top of the rectangle. A percentage completion of the task is also indicated by the corresponding text (such as “25%”, “100%”, etc.) and the shaded (using horizontal lines) region within the corresponding TGO.

The height (along the vertical direction) of a TGO indicates the number of days that the corresponding task is to be performed, while the width (along the horizontal direction) of the TGO indicates the number of hours (duration) to be spent on performing the corresponding task the task each day. For example, the height and width of TGO 350 respectively indicates that task “Task A130” is to be performed for one day for the duration of 4 hours (half the width of column 321 indicating 8 hours). Similarly, TGO 355 indicates that task “Task A140” is to be performed for 4 working days (excluding the two non-working days in between) for the duration of 6 hours each day (based on the relative width of TGO 355 with respect to column 322).

The task allocated to each resource is indicated by the presence of the corresponding TGOs in vertical columns 321-323 corresponding to the resource. For example, the presence of the four TGOs in vertical column 321 indicates that the corresponding four tasks named “Task A100”, “Task A110”, “Task A120”, and “Task A130” have been allocated to resource “John”. The completely (horizontal line) shaded TGOs for “Task A100” and “Task A110” (along with the text “100%”) below current date line 340 indicates that the two tasks have been completed by resource “John”, while the partially shaded TGO for “Task A120” indicates that the task has been performed partially (in this case, 25%). The non-shaded TGO 350 for “Task A130” above current date line 340 indicates that the resource “John” has not yet started the task (and will commence the task immediately/soon since the task is near to/above current date line 340).

It may be appreciated that multiple TGOs may be present on a specific day for a resource (thereby indicating the different tasks to be performed by the resource on the specific day). For example, the presence of TGOs for “Task A120” and “Task A130” on “Friday the 24^{th} of August 2012” for resource “John” indicates that the resource “John” has to perform on 24^{th}, both the tasks “Task A120” and “Task A130” for respective durations of 4 hours each (that is, half of the daily capacity on each task based on the respective widths of the TGOs). On the other hand, resource “John” is indicated to perform only the task “Task A120” on “Monday the 27^{th} of August 2012”.

In one embodiment, the horizontal span of a vertical column corresponds to the actual working hours of the resource, with the leftmost and rightmost points in the span respectively representing the beginning and end of the working hours (for example, 9:30 am in the morning and 6:30 pm on the evening). Accordingly, the position of the TGOs within a span of a day indicates the order (and the times) of performing the corresponding tasks. For example, for “Friday the 24^{th} of August 2012”, based on the positions of the TGOs for “Task A120” and “Task A130”, resource “John” is indicated as performing the task “Task A120” during (the four hours of) the morning session, and then performing the task “Task A130” during (the four hours of) the evening/post-lunch session. A manager may change the order of performing the tasks by placing the different TGOs in the desired sequence from left to right in the horizontal span.

It may be appreciated that the visual coverage of the horizontal span (daily capacity) for a specific day by the different TGOs indicates the utilization of the resource for the specific day. For example, the utilization of resource “John” is indicated to be 100% on 24^{th} August due to the horizontal span of 8 hours being completed covered by tasks “Task A120” and “Task A130”, while the utilization on 27^{th} August is indicated to be only 50% since only 4 hours of the total span of 8 hours is shown to be covered by “Task A120”. The absence of any tasks for a specific (working) day for a resource indicates that the utilization of the resource for the specific day is 0%.

Similarly, the TGOs shown in the other vertical columns 322 and 323 indicate the corresponding tasks allocated to the respective resources “Michael” and “Brian” and also the corresponding days and durations for performance of each allocated task. It may be observed that the TGO for “Task A150” is shown starting only on “Monday the 27^{th}”, much after/above current date line 340, thereby indicating that the “Task A150” is a future task that the resource “Michael” has to perform. Thus, the presence of the different TGOs (at corresponding different locations) in UGI 310 indicates the various tasks that have been allocated to different resources.

Unassigned tasks 360, shown as a vertical column (similar to columns 321-323, but with a width/daily capacity of 24 hours per day), indicates the various tasks that have not yet been allocated to resources. Examples of such unallocated tasks are “Task A200”, “Task A170”, “Task A310”, “Task A290”, etc. Each task is shown as being of a corresponding number of days (as indicated by the height of the TGO) and a duration/number of hours each day (as indicated by the width of the TGO).

A manager may allocate desired resources (shown in UGI 310) to the unallocated tasks shown in unassigned tasks 360. In addition as noted above, a manager may use the interfaces of UGI 310 and unassigned tasks 360 to remove previously allocated resources from tasks, and to move allocated tasks from one resource to another resource. The manner in which a manager may perform such allocations of resources to tasks is described below with examples.

### 6. Allocating Resources

Broadly, a manager drags and drops (in other words, “places”) TGOs corresponding to different tasks from unassigned tasks 360 to UGI 310 to allocate corresponding resources to respective tasks. For example, a manager may drag TGO 365 (corresponding to task “Task A200”) from unassigned tasks 360 and drop/place TGO 365 to a selected one (such as 322) of the vertical columns in UGI 310 for allocating the resource corresponding to the selected vertical column (“Michael”) to the dragged and dropped task/TGO (“Task A200”).

FIG. 3B illustrates the manner in which a manager is facilitated to allocate resources to tasks in one embodiment Similar numbers are used to represent similar portions of the user interface, and accordingly the description of such portions is not repeated again for conciseness. Display area 300 of FIG. 3B depicts a portion of a user interface that may be displayed to a manager in response to receiving various inputs, such as dragging and dropping of different/desired TGOs (to selected vertical columns) in the user interface of FIG. 3A.

TGO 370 (corresponding to “Task A200”) is shown in vertical column 322, in response to a manager dragging TGO 365 (of FIG. 3A) from unassigned tasks 360 and dropping TGO 365 in vertical column 322, as noted above. The task “Task A200” is accordingly allocated to resource “Michael”, with the position of TGO 370 indicating that the resource “Michael” is to perform task “Task A200” on the 30^{th} and 31^{st} of August 2012, for a duration of 8 hours each day. It may be observed that the height and width of TGO 370 corresponds to the width and height of TGO 365 in FIG. 3A.

It may be appreciated, that a manager may similarly reallocate currently allocated tasks between different resources by placing the desired TGOs between a desired source vertical column (corresponding to the resource currently allocated the task) to a target vertical column (corresponding to the resource to whom the task is to be reallocated) in UGI 310. For example, a manager may drag and drop TGO 350 from source vertical column 321 to target vertical column 323 for reallocating the task “Task A130” from resource “John” to resource “Brian”.

TGO 372 (corresponding to “Task A130”) is shown in column 323 indicating that the task “Task A130” is to be performed by resource “Brian”, in response to the manager dragging and dropping TGO 350 from column 321 to column 323 in the interface of FIG. 3A, as noted above. It may be observed that TGO 350 is not shown in column 321, indicating that the resource “John” is no longer allocated the task “Task A130”. Thus, the task “Task A130” is indicated to be reallocated from resource “John” to resource “Brian”.

Though not shown, it may be appreciated that the allocation of a resource to a task may be similarly removed. For example, a manager may drag and drop a TGO corresponding to an allocated task from a selected one of vertical columns 321-323 to unassigned tasks 360 to remove the allocation of the resource (corresponding to the selected column) to the task. The manager may thereafter allocate the same task to another resource, similar to dragging and dropping TGO 365, as noted above. Furthermore, the reallocation of 100% completed tasks (from below current date line 340 to a day above current date line 340) may indicate that the tasks have additional activities that need to be performed for completion.

An aspect of the present invention facilitates a manager to change the height and width of a TGO (and correspondingly restructure the number of days and hours per day for the task) during the dragging and dropping of the TGO between different columns (including unassigned tasks 360) of FIG. 3A. Such resizing/restructuring may be necessary to fit the different tasks within the capacities of the resources. The resizing may be performed keeping the total numbers of hours for the task to be same.

For example, TGO 375 (corresponding to “Task A160”) is shown in column 321 indicating that the task “Task A160” is to be performed by resource “John” for two days for the duration of 4 hours each day. However, it may be observed that TGO 368 corresponding to “Task A160” in FIG. 3A indicates that the task is to be performed for a single day for the duration of 8 hours. TGO 375 is displayed in response to a manager dragging and dropping TGO 368 from unassigned tasks 360 to vertical column 321, and then resizing the height and width of TGO 368 from “1 day×8 hours” to “2 days×4 hours” (keeping the total number of hours to be 8 hours in both cases).

In one embodiment, such resizing of a TGO (and the restructuring of the corresponding task) is performed automatically by management tool 150. The term “automatically” implies that when a manager changes one of the dimensions (height or width) of a TGO, management tool 150 computes the other dimension (width or height respectively) of the TGO and then displays the TGO according to the user specified and computed dimensions. The computation is performed as the total number of hours divided by the value of the user specified dimension. Accordingly, management 150 allows a manager to allocate only the possible different combinations of heights/days and widths/hours for each task. As such, the resizing/restructuring of TGOs/tasks is simplified for a manager.

It may be appreciated that such automatic resizing of the TGOs may also be performed to take into consideration non-working days. In particular, when a TGO is dropped on a non-working day, management tool 150 changes the height of the TGO such that the total number of working hours for the task remains the same. For example, TGO 378 (corresponding to “Task A250”) is shown automatically resized to take into consideration the two non-working days in the middle of performance of the task. It may be observed that the total number of hours represented by TGO 378 and also the TGO corresponding to “Task A250” in FIG. 3A remains the same (8 hours).

Thus, a manager is facilitated to allocate desired resources to various tasks using the interfaces of FIGS. 3A and 3B. It may be appreciated that the tasks may be associated with different constraints, and the allocation of resources to the tasks need to be performed according to the associated constraints. The manner in which management tool 150 facilitates a manager to allocate resources based on task constraints is described below with examples.

### 7. Task Constraints

According to an aspect of the present invention, the constraints associated with the tasks are presented visually as part of the corresponding TGOs, thereby enabling a manager to allocate resource based on visual indicators of the constraints. According to another aspect, the movement (and also the placement) of the TGOs is restricted according to the constraints specified for the corresponding tasks.

FIG. 3C illustrates example task constraints and corresponding visual indicators displayed in one embodiment. For example, a task may be associated with date constraints such as a start date at which the task is required to be started, an end date before which the task is required to be completed and a maximum number of days to be used for completing the task. Such date constraints on the start date and end date for a task are visually indicated by respective thick lines at the bottom and top of the corresponding TGO. For example, TGO 382 has thick bottom and top lines indicating that task “Task A150” has a start date constraint of 27^{th} August and an end date constraint of 29^{th} August. The maximum days constraint may be similarly specified, such as TGO 384 which indicates a maximum days constraint of 1 for “Task A240”.

In response to a manager dragging TGOs (such as 382 and 384) with date constraints, management tool 150 allows the manager to drop such dragged TGOs in only specific portions of the vertical columns 321-323 as determined by the date constraints. For example, management tool 150 allows a manager to drag and drop TGO 382 (for example, to reallocate the task “Task A150”) to only the other portions of vertical columns 321-323 between 27^{th} August and 29^{th} August. Furthermore, during such a drag and drop, management tool 150 may ensure that any resizing of the TGO is consistent with the date constraints (for example, by ensuring that the height of the TGO is not changed).

Another constraint that may be specified for a task is a “duration constraint” which indicates the maximum duration (number of hours) per day that can be spend on the task. Such a duration constraint is visually indicated by thick lines at the left and right sides of the corresponding TGO. For example, TGO 386 has thick left and right lines indicating that the task “Task A090” can be performed for a maximum of 2 hours per day. Again, similar to date constraints, management tool 150 may allow a manager to only place TGOs/tasks with duration constraints in specific portions of vertical columns 321-323 and also ensure that resizing of the TGOs is consistent with the duration constraints.

The tasks may also be associated with dependency constraints and corresponding visual indicators may be displayed in UGI 310. For example, two tasks may have a finish-to-start dependency implying that the second task cannot be started before the first task is finished/completed. A predecessor dependency indicating that a current task depends on the completion of a previous task is visually indicated as a thick dot at the bottom left corner of the TGO corresponding to the current task, while a successor dependency indicating that a future task depends on the completion of the current task is visually indicated as a thick dot at the top right corner of the TGO.

Thus, the two thick dots at the boundary of TGOs 392 and 394 indicates that there is a finish-to-start dependency between the corresponding tasks “Task A230” and “Task A270” such that the successor task “Task A270” cannot be started until predecessor task “Task A230” is completed. Similarly, another finish-to-start dependency is specified between successor task “Task A070” and predecessor task “Task A060” by the dots on the boundary between the corresponding TGOs. Management tool 150 may restrict the movement of the corresponding TGOs when a manager is allocating resources to the tasks. For example, after a manager places TGO 394, management tool 150 may allow the manager to drag and drop TGO 392 only below TGO 392 (that is, without overlapping or moving beyond TGO 394 on the timeline) such that the finish-to-start dependency is maintained.

It may be appreciated that a task may be associated with more than one of the constraints noted above. Management tool 150 accordingly displays the TGO (corresponding to such a task) with the different visual indicators corresponding to the different constraints associated with the task. For example, the TGO corresponding to the task “Task A300” is shown having a thick line at the top and a thick dot at the bottom left corner thereby indicating that the task “Task A300” has an end date constraint and also a predecessor dependency.

According to an aspect of the present invention, UGI 310 also facilitates a user/manager to get a visual “feel” of the (amount of) slack time available for a task. The slack time refers to the possible number of days during which a resource is available/unallocated before the start date of a next allocated task. Such slack time may be present due to the allocation of the next task, the possible completion (by the resource) of the previous task ahead of the number of days allocated for the previous task, etc. Management tool 150, accordingly, facilitates the user to drag/move down the TGO for the next task (thereby expediting the next task) or drag/move up the TGO for the previous task (thereby postponing the previous task) in UGI 310.

For example, a resource may complete a previous/predecessor task (such as “Task A230”) 1 day ahead of the allocated end date, while a next/successor task (such as “Task A270”) may be allocated as having a start date 2 days after the end date of the previous task. Thus, the resource may be viewed as having a slack time of (1+2=) 3 days. Accordingly, management tool 150 may allow the user/manager to drag down TGO 392 by 1 day (for the original placement, not shown in the Figures), or drag up TGO 394 by 2 days (from the original placement, not shown in the Figures).

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

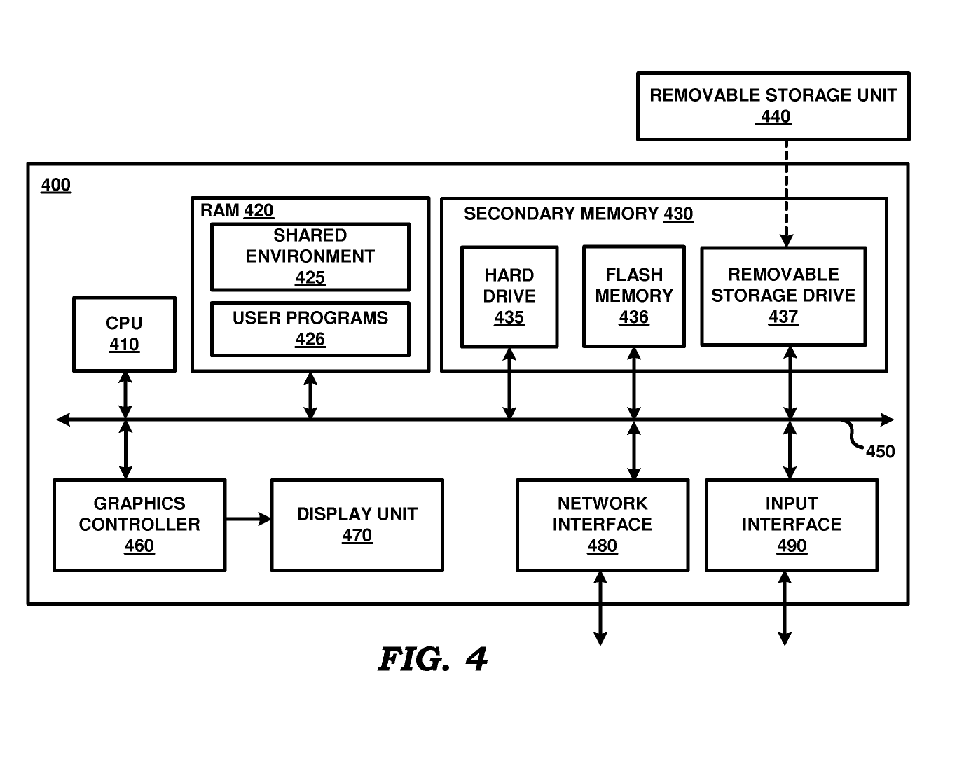

FIG. 4 is a block diagram illustrating the details of digital processing system 400 in which various aspects of the present invention are operative by execution of appropriate software instructions. Digital processing system 400 may correspond to management tool 150 or one of end user systems 160A-160X.

Digital processing system 400 may contain one or more processors such as a central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of the present invention. CPU 410 may contain multiple processing units, with each processing unit potentially being designed for a specific task. Alternatively, CPU 410 may contain only a single general-purpose processing unit.

RAM 420 may receive instructions from secondary memory 430 using communication path 450. RAM 420 is shown currently containing software instructions constituting shared environment 425 and/or user programs 426 (such as client applications, Web browser, RDBMS, etc.). Shared environment 425 includes operating systems, device drivers, virtual machines, etc., which provide a (common) run time environment for execution of user programs 426.

Graphics controller 460 generates display signals (e.g., in RGB format) to display unit 470 based on data/instructions received from CPU 410. Display unit 470 contains a display screen to display the images (e.g., portions of the user interface shown in FIGS. 3A-3B) defined by the display signals. Input interface 490 may correspond to a keyboard and a pointing device (e.g., touch-pad, mouse) and may be used to provide inputs (e.g., drag and drop of tasks, etc. using the user interface shown in FIGS. 3A-3B). Network interface 480 provides connectivity to a network (e.g., using Internet Protocol), and may be used to communicate with other systems (such as those shown in FIG. 1) connected to the network.

Secondary memory 430 may contain hard drive 435, flash memory 436, and removable storage drive 437. Secondary memory 430 may store the data and software instructions (e.g., for performing the actions of FIG. 2), which enable digital processing system 400 to provide several features in accordance with the present invention.

Some or all of the data and instructions may be provided on removable storage unit 440, and the data and instructions may be read and provided by removable storage drive 437 to CPU 410. Floppy drive, magnetic tape drive, CD-ROM drive, DVD Drive, Flash memory, removable memory chip (PCMCIA Card, EEPROM) are examples of such removable storage drive 437.

Removable storage unit 440 may be implemented using medium and storage format compatible with removable storage drive 437 such that removable storage drive 437 can read the data and instructions. Thus, removable storage unit 440 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 440 or hard disk installed in hard drive 436. These computer program products are means for providing software to digital processing system 400. CPU 410 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 9. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of facilitating allocation of resources to tasks, said method comprising:
receiving inputs representing a plurality of tasks, a plurality of resources, and duration of allocation of each of said plurality of resources to respective tasks in respective days; and
sending for display a unified graphical interface (UGI) indicating said plurality of tasks, the corresponding ones of said plurality of resources allocated for each task, and an extent of utilization of each of said resource in each day.

2. The method of claim 1, wherein said UGI comprises:
the identifiers and daily capacities of each of said plurality of resources along a first direction;
a timeline identifying a plurality of days along a second direction, wherein said first direction and said second direction are perpendicular to each other; and
a plurality of vertical columns, each corresponding to a respective one of said plurality of resources, wherein a width of a vertical column identifies the daily capacity of the corresponding resource.

3. The method of claim 2, wherein said UGI further comprises a plurality of task graphical objects (TGOs) representing respective tasks allocated to each of said plurality of resources,
a first TGO of said plurality of TGOs being placed in a first vertical column of said plurality of vertical columns, said first vertical column corresponding to a first resource of said plurality of resources, said first TGO representing a first task of said plurality of tasks,
wherein said first TGO indicates that said first resource is allocated to said first task,
wherein a height of said first TGO along said second direction indicates a number of days said first resource is allocated to said first task,
wherein a width of said first TGO along said first direction indicates a duration of allocation of said first resource to said first task for each of said number of days,
wherein a relative position of said first TGO along said first direction in a day indicates the expected specific working hours of said day allocated to said first task.

4. The method of claim 3, further comprising:
sending for display a set of unallocated tasks, wherein said set of unallocated tasks are displayed contemporaneous with said UGI.

5. The method of claim 4, wherein said inputs comprise a first input indicating that a user has placed a second TGO in said first vertical column at a first location, said second TGO representing a second task of said set of unallocated tasks, said first location corresponding to a first day of said plurality of days, said method further comprising:
including said second TGO starting at said first location in said first vertical column of said UGI to indicate that said first resource is allocated to said second task.

6. The method of claim 5, wherein some of said plurality of tasks are associated with a set of constraints,
wherein said set of constraints comprises a start date constraint, an end date constraint, maximum duration per day constraint, a predecessor constraint and successor constraint,
wherein each of said set of constraints is indicated by a corresponding visual indicator associated with respective TGOs in said UGI.

7. The method of claim 5, wherein said first task is indicated to be completed on a second day of said plurality of days, said second day of said first task being before said first day of said second task, wherein the difference in the number of days from said second day and said first day indicates a slack time of said first resource between said first task and said second task, said method further comprising:
enabling said user to move down said second TGO such that said first day is changed to a previous day after said first day, and to move up said first TGO such that said second day is changed to a later day before said second day,
whereby said user is provided a visual representation of said slack time between said first task and said second task.

8. A non-transitory machine readable medium storing one or more sequences of instructions for causing a system to facilitate allocation of resources to tasks, wherein execution of said one or more instructions by one or more processors contained in said system causes said system to perform the actions of:
receiving inputs representing a plurality of tasks, a plurality of resources, and duration of allocation of each of said plurality of resources to respective tasks in respective days; and
sending for display a unified graphical interface (UGI) indicating said plurality of tasks, the corresponding ones of said plurality of resources allocated for each task, and an extent of utilization of each of said resource in each day.

9. The machine readable medium of claim 8, wherein said UGI comprises:
the identifiers and daily capacities of each of said plurality of resources along a first direction;
a timeline identifying a plurality of days along a second direction, wherein said first direction and said second direction are perpendicular to each other; and
a plurality of vertical columns, each corresponding to a respective one of said plurality of resources, wherein a width of a vertical column identifies the daily capacity of the corresponding resource.

10. The machine readable medium of claim 9, wherein said UGI further comprises a plurality of task graphical objects (TGOs) representing respective tasks allocated to each of said plurality of resources,
a first TGO of said plurality of TGOs being placed in a first vertical column of said plurality of vertical columns, said first vertical column corresponding to a first resource of said plurality of resources, said first TGO representing a first task of said plurality of tasks,
wherein said first TGO indicates that said first resource is allocated to said first task,
wherein a height of said first TGO along said second direction indicates a number of days said first resource is allocated to said first task,
wherein a width of said first TGO along said first direction indicates a duration of allocation of said first resource to said first task for each of said number of days,
wherein a relative position of said first TGO along said first direction in a day indicates the expected specific working hours of said day allocated to said first task.

11. The machine readable medium of claim 10, further comprising one or more instructions for:
sending for display a set of unallocated tasks, wherein said set of unallocated tasks are displayed contemporaneous with said UGI.

12. The machine readable medium of claim 11, wherein said inputs comprise a first input indicating that a user has placed a second TGO in said first vertical column at a first location, said second TGO representing a second task of said set of unallocated tasks, said first location corresponding to a first day of said plurality of days, further comprising one or more instructions for:
including said second TGO starting at said first location in said first vertical column of said UGI to indicate that said first resource is allocated to said second task.

13. The machine readable medium of claim 12, wherein some of said plurality of tasks are associated with a set of constraints,
wherein said set of constraints comprises a start date constraint, an end date constraint, maximum duration per day constraint, a predecessor constraint and successor constraint,
wherein each of said set of constraints is indicated by a corresponding visual indicator associated with respective TGOs in said UGI.

14. The machine readable medium of claim 12, wherein said first task is indicated to be completed on a second day of said plurality of days, said second day of said first task being before said first day of said second task, wherein the difference in the number of days from said second day and said first day indicates a slack time of said first resource between said first task and said second task, further comprising one or more instructions for:
enabling said user to move down said second TGO such that said first day is changed to a previous day after said first day, and to move up said first TGO such that said second day is changed to a later day before said second day,
whereby said user is provided a visual representation of said slack time between said first task and said second task.

15. A digital processing system comprising:
a processor;
a random access memory (RAM);
a machine readable medium to store one or more instructions, which when retrieved into said RAM and executed by said processor causes said digital processing system to facilitate allocation of resources to tasks, said digital processing system performing the actions of:
receiving inputs representing a plurality of tasks, a plurality of resources, and duration of allocation of each of said plurality of resources to respective tasks in respective days; and
sending for display a unified graphical interface (UGI) indicating said plurality of tasks, the corresponding ones of said plurality of resources allocated for each task, and an extent of utilization of each of said resource in each day.

16. The digital processing system of claim 15, wherein said UGI comprises:
the identifiers and daily capacities of each of said plurality of resources along a first direction;
a timeline identifying a plurality of days along a second direction, wherein said first direction and said second direction are perpendicular to each other; and
a plurality of vertical columns, each corresponding to a respective one of said plurality of resources, wherein a width of a vertical column identifies the daily capacity of the corresponding resource.

17. The digital processing system of claim 16, wherein said UGI further comprises a plurality of task graphical objects (TGOs) representing respective tasks allocated to each of said plurality of resources,
a first TGO of said plurality of TGOs being placed in a first vertical column of said plurality of vertical columns, said first vertical column corresponding to a first resource of said plurality of resources, said first TGO representing a first task of said plurality of tasks,
wherein said first TGO indicates that said first resource is allocated to said first task,
wherein a height of said first TGO along said second direction indicates a number of days said first resource is allocated to said first task,
wherein a width of said first TGO along said first direction indicates a duration of allocation of said first resource to said first task for each of said number of days,
wherein a relative position of said first TGO along said first direction in a day indicates the expected specific working hours of said day allocated to said first task.

18. The digital processing system of claim 17, further performing the actions of:
sending for display a set of unallocated tasks, wherein said set of unallocated tasks are displayed contemporaneous with said UGI.

19. The digital processing system of claim 18, wherein said inputs comprise a first input indicating that a user has placed a second TGO in said first vertical column at a first location, said second TGO representing a second task of said set of unallocated tasks, said first location corresponding to a first day of said plurality of days, further performing the actions of:
including said second TGO starting at said first location in said first vertical column of said UGI to indicate that said first resource is allocated to said second task.

20. The digital processing system of claim 19, wherein some of said plurality of tasks are associated with a set of constraints,
wherein said set of constraints comprises a start date constraint, an end date constraint, maximum duration per day constraint, a predecessor constraint and successor constraint,
wherein each of said set of constraints is indicated by a corresponding visual indicator associated with respective TGOs in said UGI.
